(19) United States
(12) Patent Application Publication
(10) Pub. No.: US 2015/0233697 A1
(43) Pub. Date: Aug. 20, 2015

(54) Measuring Instrument and Method

(71) Applicant: ELCOMETER LIMITED, Manchester Lancashire (GB)

(72) Inventors: Michael Carrington Sellars, Manchester (GB); Gordon Peter Clark, Manchester (GB)

(73) Assignee: ELCOMETER LIMITED, Manchester, Lancashire (GB)

(21) Appl. No.: 14/434,632

(22) PCT Filed: Oct. 9, 2013
(86) PCT No.: PCT/GB2013/052622

§ 371 Date: Apr. 9, 2015

(30) Foreign Application Priority Data
Oct. 9, 2012 (GB) 1218042.8

(51) Int. Cl. G01B 7/06

(52) U.S. Cl. CPC G01B 7/06

(57) ABSTRACT

A measuring instrument, such as a coating thickness measuring instrument, comprises a reader (6) arranged to read information provided on a calibration piece article (7), such as a calibration foil. The reader (6) can be an RFID reader and the information provided in a RFID tag. The information may be used to calibrate the instrument when the instrument is used to measure a property of the calibration piece. The reader (6) may also be used to read information provided on an article to be measured, to identify the article or a location on the article, or on a detachable probe of the instrument.

### FIELD OF THE INVENTION

The present invention relates to a measuring instrument, and to methods of making measurements. The invention relates particularly, but not exclusively, to a coating thickness measuring instrument.

### BACKGROUND TO THE INVENTION

A conventional coating thickness measuring instrument employs a probe which relies on magnetic induction in a coated metal substrate to enable the distance between the probe and the substrate to be measured when the probe is brought into contact with a coated surface of the substrate, and thereby determine the thickness of the coating. The accuracy of the technique is highly dependent on the electrical conductivity and magnetic properties of the substrate. So, in order to obtain accurate measurements, the instrument must be calibrated for each type of substrate on which measurements are to be taken using a set of calibration foils of known thickness. A foil of known thickness is placed onto a bare sample of substrate, the probe placed over the foil and a thickness measurement is taken. The instrument can then be calibrated so that the measured thickness corresponds to the known thickness of the foil. Owing to the non-linear nature of the measurement technique it is usually necessary for a number of calibration readings to be made using a range of calibration foils of different thickness to properly calibrate the instrument to make readings on a given substrate.

To simplify the process for a user, the instrument is arranged to prompt a user to make calibration readings using calibration foils via a display screen. However, because the precise thickness of calibrations foils cannot be well controlled, to ensure accuracy, it is necessary for the user to manually enter the thickness of each calibration foil used. This is time consuming and introduces the possibility that foil thickness is entered incorrectly, which would lead to incorrect calibration of the instrument.

Some types of existing coating thickness measuring instrument employ a detachable probe, allowing different probes to be used with the instrument. The characteristics of individual probes vary, so to maintain accuracy of the measurement system the instrument should be provided with details of the characteristics of the probe with which it is used. In effect, therefore, the instrument also has to be calibrated to a particular probe, which raises similar issues as to calibration to a particular substrate.

Measuring instruments are often used to make repeated measurements of given articles and/or repeated measurements of particular parts of articles. For example, a coating thickness measuring instrument may be used to regularly check the thickness of a coating applied to a bridge. Repeated measurements of different articles and locations need to be recorded in relation to the article or location for later analysis. Creating an appropriate record whilst making measurements is time consuming and allows the potential for error.

Embodiments of the present invention have been made in consideration of these issues.

### SUMMARY OF THE INVENTION

According to the an aspect of the present invention there is provided a measuring instrument comprising a reader arranged to read information provided on a calibration piece and a processor arranged to calibrate the instrument using information read from the calibration piece by the reader together with a measurement of a property of the calibration piece made by the instrument.

The reader enables the instrument to read information from a calibration piece, which would typically relate to a property of the calibration piece. So the invention enables calibration data to be automatically entered into a measuring instrument that has hitherto been entered manually. This saves time, and reduces the risk of error.

The processor may calibrate the instrument by adjusting the instrument so that the measured property of the calibration piece is substantially equal to a value of the property determined by the reader by reading information from the calibration piece.

The reader could be any suitable non-contact reader, for example a wireless reader such as a radio frequency identification reader, an optical reader or a magnetic reader.

The measuring instrument may be for measuring coating thickness. The invention is, however, applicable to a whole range of measuring instruments such as surface and profile roughness meters, gloss and reflectance meters and ultrasonic thickness gauges.

The reader may also be arranged to read information provided on an article to be measured and the processor arranged to associate the information with a measurement made of the article. This information could be a description of the article and/or a location on the article.

The reader may also be arranged to read information provided on a detachable probe used with the measuring instrument and the processor arranged to process readings made using the probe with the information read from the probe.

According to another aspect of the invention there is provided measuring apparatus comprising a measuring instrument according to the previous aspect, with or without any of its optional features, and one or more calibration pieces, each calibration piece comprising information relating to a property of that calibration piece in a form which may be read by the reader. This form could be a radio frequency identification tag, bar or other optical code or magnetic strip, or any other suitable machine readable form.

The one or more calibration pieces may be calibration foils and comprise information relating to their thickness. Where the instrument is a gloss meter the one or more calibration pieces may comprise information relating to their glossiness.

According to another aspect of the invention there is provided a method of calibrating a measuring instrument comprising the steps of:
providing a measuring instrument comprising a reader arranged to read information provided on another article;
providing a calibration piece comprising information relating to a property of the calibration piece in a form readable by the reader of the measuring instrument;
measuring the said property of the calibration piece using the measuring instrument; and reading the information comprised in the calibration piece using the reader of the instrument.
The method may comprise the further step of adjusting the instrument so that the value of the property measured by the instrument is substantially equal to the value of the property determined from the information read from the calibration piece.

According to another aspect of the invention there is provided a method of measuring a property of an article comprising the steps of:
providing a measuring instrument comprising a reader arranged to read information provided on another article;
providing information identifying the article to be measured on the article in a form which is readable by the reader of the measuring instrument;
measuring a property of the article using the instrument to obtain a value;
reading the information identifying the article to be measured using the reader of the measuring instrument; and associating the value with the information read from the article.

According to another aspect of the invention there is provided a method of measuring a property of an article at multiple points on the article comprising the steps of:
providing a measuring instrument comprising a reader arranged to read information provided on another article;
providing information on the article to be measured at multiple positions on the article in a form which is readable by the reader of the measuring instrument;
measuring a property of the article using the measuring instrument at or near a position where information is provided to obtain a value;
reading the information provided at the position using the reader of the measuring instrument; and associating the value with the information.
   The latter three steps may be repeated at different positions on the article.

According to another aspect of the invention there is provided a coating thickness measuring instrument comprising at least one detachable probe for measuring coating thickness, a reader arranged to read information provided on the or each detachable probe when the probe is fitted to the instrument and a processor, wherein the processor is arranged to process measurements made using a particular probe using information read from the probe.

The reader enables the instrument to read information from a probe used with the instrument. The information would typically relate to a property of the probe. So, the invention enables data required to enable the instrument to function correctly, when a particular probe is used, to be automatically entered into the instrument.

The reader could be any suitable non-contact reader, for example a wireless reader such as a radio frequency identification reader, an optical reader or a magnetic reader.

According to another aspect of the invention there is provided a method of measuring a coating thickness comprising the steps of:
a. providing a coating thickness measuring instrument comprising at least one detachable probe, a reader arranged to read information provided on the or each detachable probe when the probe is fitted to the instrument and a processor;
b. fitting a probe to the instrument;
c. reading information provided on the probe using the reader;
d. making a measurement of a coating thickness using the instrument; and
e. processing the measurement using the information read from the probe in order to yield a value for the measurement.

Features of any one aspect of the invention may be combined with those of any other aspect of the invention as desired or as appropriate.

### BRIEF DESCRIPTION OF THE DRAWINGS

In order that the invention may be more clearly understood embodiments thereof will now be described, by way of example, with reference to the accompanying drawings of which:

FIG. 1: is a perspective view of a coating thickness measuring instrument in use with a calibration foil;

FIG. 2: is a schematic view of the instrument of FIG. 1;

FIG. 3: is a perspective view of another coating thickness measuring instrument in use making a coating thickness measurement; and

FIG. 4: is a schematic view of the instrument FIG. 3.

### DETAILED DESCRIPTION OF THE INVENTION

In the drawings, like reference numerals are used to identify like components throughout.

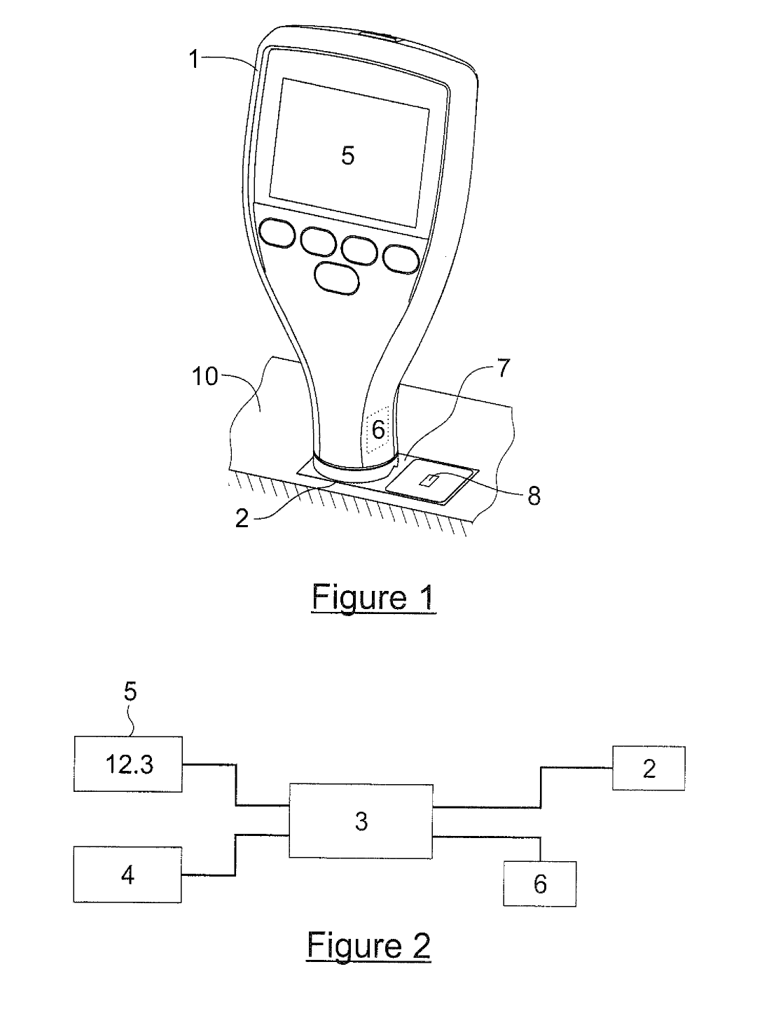

Referring to FIGS. 1 and 2, a first embodiment of a coating thickness measuring instrument comprises a housing 1. The housing houses an inductive measurement probe 2, a programmable processor 3, a user input device 4 comprising a number of buttons, an electronic display screen 5 and a radio frequency identification (RFID) reader 6. The housing may also house a power supply and interface for connection to a personal computer and other components and features common to known instruments.

The probe 2, input device 4 and display screen 5 are operatively connected to the processor and operate as for a conventional instrument. The probe 2 produces a signal which is dependent on its spacing from a suitable substrate. The input device 4 enables a user to input information into the instrument and to control its operation through menus which are displayed on the screen 5 along with the results of measurements taken by the probe 2. Operation of the instrument is driven by the processor 3 which is programmed with appropriate software.

The instrument differs from conventional instruments through the provision of an RFID reader 6 which is operatively connected to the processor 3, and through the software running on the processor 3 which enables the processor to use the RFID reader 6 to read information from RFID tags and to utilise the information which is read.

One application of the RFID reader is to facilitate calibration of the instrument. The instrument is provided with calibration foils 7, one of which is shown in FIG. 1. Each foil comprises an RFID tag 8 which stores information relating to the thickness of the foil and/or a unique identifier of the foil such as a serial number.

To calibrate the instrument, a user enters a calibration mode using the buttons comprised in the input device and is then prompted by information on the display screen 5 to take one or more calibration readings, using one or more calibrations foils, by placing the calibration foil onto the bare surface of a substrate 10 in relation to which it is desired to calibrate the instrument and then placing the probe in contact with the calibration foil. At this stage, as the instrument is brought into proximity with the calibration foil being used, the RFID reader 6 is arranged to interrogate the RFID tag 8 on the foil and read the stored thickness of the foil 8 and/or the unique identifier of the foil. This information is provided to the processor 3 and used to calibrate the instrument. The information could be used directly, or to identify other information, for example in a look up table, which is then used to calibrate the instrument. The process is repeated, as necessary, for other foils, each time the RFID reader 6 obtaining the thickness of the foil from the RFID tag 8 provided on this foil. This overcomes the need for the user to manually input the thickness of the foil, saving time and ensuring that the processor is accurately provided with the foil thickness.

The RFID reader 6 can be used to read other information from RFID tags. In one application where repeated coating thickness readings must be taken from a number of articles, or from multiple positions on one or more articles, an RFID tag may be attached to each article, or tags may be attached to multiple positions on a single article at which readings are to be taken, the tags storing information which identifies the article and/or position of the tag on the article. When a measurement is taken, the RFID reader 8 on the instrument interrogates the nearby tag on the article and the coating thickness measurement taken is associated with the tag by the processor. Thus a measurement can be automatically be identified with an article and/or a position on an article, avoiding the need for an operator to enter this information into the instrument or make a separate record of readings against article and/or position on the article.

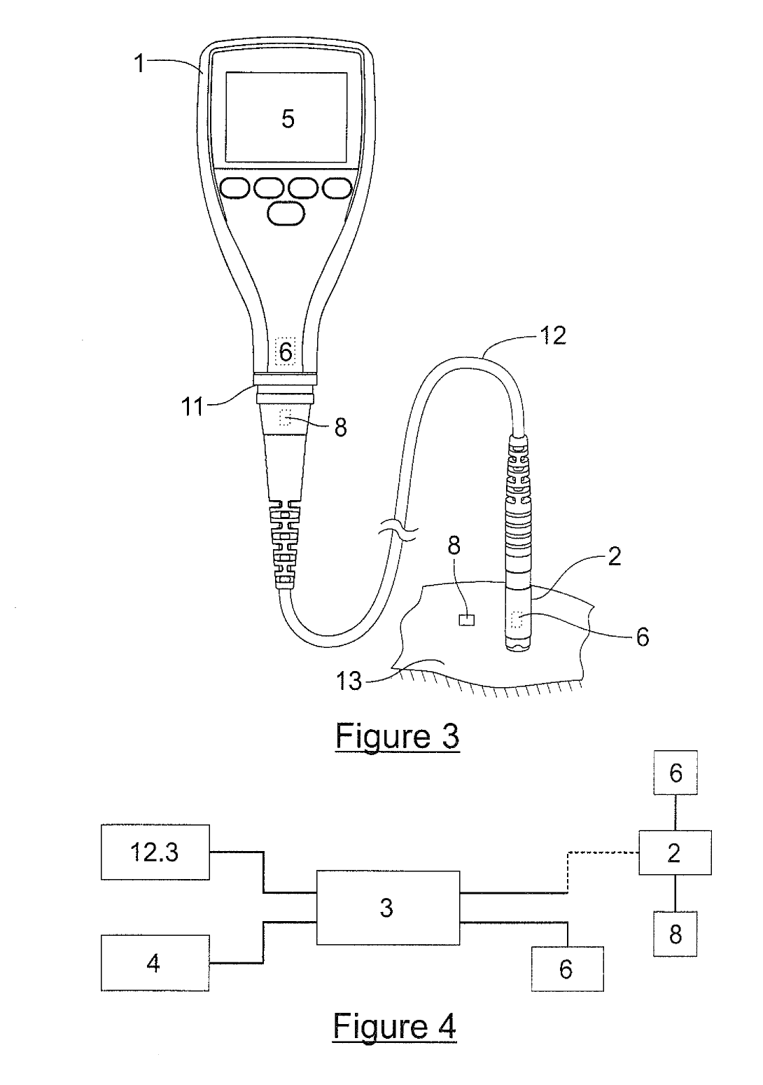

Referring to FIGS. 3 and 4 a second embodiment of a coating thickness measurement instrument is similar to that shown in FIGS. 1 and 2, except that, instead of the housing 1 containing a probe 2, it is provided with a fitting 11 with electrical connections to which a probe 2 may be releasably mounted. The enables the instrument to be used with a variety of different probes, either mounted directly to the instrument, or via an electrical cable 12 as shown.

In this case, the probe 2 is provided with an RFID reader 6 for interrogating an RFID tag 8 and information read from the tag is transmitted to the instrument via the cable 12, or a direct connection where there is no cable.

The RFID reader may, as with the example shown in FIG. 1, be used to read information from an RFID tag on a calibration foil or it may, as shown in FIG. 3, be used to read an RFID tag 8 on a coated surface 13, the tag storing information relating to its position on the surface.

The instrument shown in FIGS. 3 and 4 also includes an RFID reader disposed in its housing 1. This reader could be used in place of or in addition to the reader provided on the probe 2 to read RFID tags associated with calibration foils or articles. The reader on the instrument is also arranged to read information from an RFID tag 8 mounted on the probe 2, or electrical connector used to mount the probe to the instrument. The RFID tag associated with the probe stores information regarding the performance of the probe, which is used by the processor 3 to optimise readings taken by the probe, for example by taking account of the individual probe's response compared to its theoretical design response.

The present invention greatly facilitates the calibration and use of thickness measurement instruments as well as improving accuracy by reducing the opportunity for a user error.

The above embodiments are described by way of example only. Many variations are possible without departing from the invention as defined by the following claims.

1. A measuring instrument comprising a reader arranged to read information provided on a calibration piece and a processor arranged to calibrate the instrument using information read from the calibration piece by the reader together with a measurement of a property of the calibration piece made by the instrument.

2. A measuring instrument as claimed in claim 1 wherein the processor is arranged to calibrate the instrument by adjusting the instrument so that the measured property of the calibration piece is substantially equal to a value of the property determined by the reader by reading information from the calibration piece.

3. A measuring instrument as claimed in claim 1 wherein the reader is a wireless reader.

4. A measuring instrument as claimed in claim 3 wherein the reader is a radio frequency identification reader, an optical reader or a magnetic reader.

5. A measuring instrument as claimed in claim 1 wherein the instrument is for measuring coating thickness.

6. A measuring instrument as claimed in claim 1 wherein the reader is also arranged to read information provided on an article to be measured and the processor is also arranged to associate the information with a measurement made of the article.

7. A measuring instrument as claimed in claim 1 wherein the reader is also arranged to read information provided on a detachable probe used with the measuring instrument and the processor is also arranged to process readings made using the probe with the information read from the probe.

8. Measuring apparatus comprising a measuring instrument as claimed in claim 1 and one or more calibration pieces, each calibration piece comprising information relating to a property of that calibration piece in a form which may be read by the reader.

9. Measuring apparatus as claimed in claim 8 wherein the one or more calibration pieces are calibration foils and comprise information relating to their thickness.

10. Measuring apparatus as claimed in claim 8 wherein the one or more calibrations pieces comprise information relating to their glossiness.

11. A method of calibrating a measuring instrument comprising the steps of:
a. providing a measuring instrument as claimed in claim 1;
b. providing a calibration piece comprising information relating to a property of the calibration piece in a form readable by the reader of the measuring instrument;
c. measuring the said property of the calibration piece using the measuring instrument and recording a measured value; and
d. reading the information comprised in the calibration piece using the reader of the instrument.

12. A method of calibrating a measuring instrument as claimed in claim 11 comprising the further step of adjusting the instrument so that the recorded value of the property measured by the instrument is substantially equal to the value of the property determined from the information read from the calibration piece.

13. A method of measuring a property of an article comprising the steps of:
a. providing a measuring instrument as claimed in claim 1;
b. providing information identifying the article to be measured on the article in a form which is readable by the reader of the measuring instrument;
c. measuring a property of the article using the instrument to obtain a value;
d. reading the information identifying the article to be measured using the reader of the measuring instrument; and
e. associating the value with the information read from the article.

14. A method of measuring a property of an article at multiple points on the article comprising the steps of:
a. providing a measuring instrument as claimed in claim 1;
b. providing information on the article to be measured at multiple positions on the article in a form which is readable by the reader of the measuring instrument;
c. measuring a property of the article using the measuring instrument at or near a position where information is provided to obtain a value;
d. reading the information provided at the position using the reader of the measuring instrument; and
e. associating the value with the information.

15. A method of measuring a property of an article at multiple points on the article as claimed in claim 14 comprising the step of repeating steps c. to e. at different positions.

16. A coating thickness measuring instrument comprising at least one detachable probe for measuring coating thickness, a reader arranged to read information provided on the or each detachable probe when the probe is fitted to the instrument and a processor, wherein the processor is arranged to process measurements made using a particular probe using information read from the probe.

17. A measuring instrument as claimed in claim 16 wherein the reader is a non-contact reader.

18. A measuring instrument as claimed in claim 17 wherein the reader is a radio frequency identification reader, an optical reader or a magnetic reader.

19. A method of measuring a coating thickness comprising the steps of:
a. providing a measuring instrument as claimed in claim 16;
b. fitting a probe to the instrument;
c. reading information provided on the probe using the reader;
d. making a measurement of a coating thickness using the instrument; and
e. processing the measurement using the information read from the probe in order to yield a value for the measurement.
